(19) United States
(12) Patent Application Publication
(10) Pub. No.: US 2004/0098172 A1
(43) Pub. Date: May 20, 2004

(54) Configuration system for network appliances, and a method for reconfiguration of appliances

(75) Inventors: Bernhard Deck, Weilheim (DE); Mario Crevatin, Winterthur (CH); Catherine Korbacher, Baden-Dattwil (CH); Hans-Peter Zuger, Hausen (CH); Paul Rudolf, Villigen (CH)

Correspondence Address: BURNS DOANE SWECKER & MATHIS L L P, POST OFFICE BOX 1404, ALEXANDRIA, VA, 22313-1404, US

(73) Assignee: ABB Research Ltd., Zurich (CH)

(21) Appl. No.: 10/702,734

(22) Filed: Nov. 7, 2003

(30) Foreign Application Priority Data
Nov. 15, 2002 (EP) 02405983.4

(51) Int. Cl. G05D 3/12

(52) U.S. Cl. 700/295

(57) ABSTRACT

The invention relates to a configuration system for configuration of appliances in networks, for example substation control technology, having at least one appliance to be configured and having elements which are configured in a specific manner, and configuration means for reconfiguration of the appliance on the basis of received new configuration information; and a configuration server, which is connected via a network to the at least one appliance to be configured and which has composition means for creation of new configuration information for the appliance to be configured and means for determination of the present configuration of the at least one appliance to be configured. The invention likewise relates to a corresponding configuration method.

### DESCRIPTION

### TECHNICAL FIELD

The invention relates to a configuration system for configuration of appliances in networks, and to a method for reconfiguration of such appliances. The method may be used in particular in the field of substation technology.

### PRIOR ART

The number of networks in use throughout the world with configurable appliances is increasing continuously. Appliances such as these are used in widely differing fields of operation, for example in the field of data processing networks in office environments, in the field of telecommunications, and in the field of substation technology, such as the technology for electricity, water or gas distribution. All of these networks have the common feature that intelligent electronic appliances, which switch functions or monitor functions and/or states, are connected to one another by means of communication networks, and are connected to control instances. These networks are distributed over a wide area in particular in the field of large systems, for example throughout the entire coverage area of a specific electricity supplier. The intelligent electronic appliances that are used in general have a configuration which corresponds to their purpose in that environment. The expression configuration in this case means the totality of all the settings of an appliance which determine and/or influence its behavior, that is to say its states with respect to the environment. The intelligent electronic appliances that are used are generally universal appliances, which can be used for widely differing purposes and can thus be configured as required. This is generally done with the aid of a control program which can access hardware ports which can then control, influence or read etc. switches or sensors, for example, in a predetermined manner. These devices can be reconfigured for operation of the appliances when the conditions change. This is normally done either by the companies who manufacture the appliances or by maintenance companies, who have specialized in such appliances.

At the moment, appliances are configured exclusively on site, that is to say directly on the appliance to be reconfigured. This is because those people carrying out the configuration work do not generally have sufficient knowledge about the type, model or present configuration of an appliance to be reconfigured and therefore have to rely first of all on determining a present, working configuration before appropriately adapted changes can be made to the configuration, which do not render the appliance inoperable. This method involves a large amount of labor and frequently requires long travel times and thus high labor costs for the maintenance technicians on site. It would be desirable, and is thus an object of the present invention, to be able to reconfigure the appliances even via the same network to which these appliances are connected in any case without having to carry out reconfiguration on site.

### DESCRIPTION OF THE INVENTION

This object is achieved by the provision of a configuration system as claimed in the independent patent claim 1, and by the method for reconfiguration of appliances as claimed in the independent patent claim 8. Further advantageous refinements, aspects and details of the present inventions can be found in the dependent patent claims and in the description.

The invention relates first of all to a configuration system for configuration of appliances in networks having at least one appliance to be configured and having elements which are configured in a specific manner, and configuration means for reconfiguration of the appliance on the basis of received new configuration information; and a configuration server, which is connected via a network to the at least one appliance to be configured, and which has composition means for creation of new configuration information for the appliance to be configured, and means for determination of the present configuration of the at least one appliance to be configured.

The appliance to be configured may in this case be any configurable appliance which has switching states with an external effect, for example special intelligent electronic appliances for control and system engineering or data processing systems with a control functionality incorporated in them, etc. The elements which can be configured represent the hardware and software components which give the appliance the characteristics with an external effect. These may, for example, be switches, sensors, actuators, or else internal software objects such as logging programs or timing controllers.

In one preferred embodiment of the invention, the present configuration information describes not only a configuration of elements which can be configured by software and/or by remote control, but also includes configuration information relating to elements which can be configured only by manual action. Elements such as these are, for example, hardware components of control appliances and, in particular, primary appliances which are controlled by the appliance to be configured. Elements such as these cannot be reconfigured automatically on the basis of the new configuration information; the new configuration information therefore reflects the present configuration for elements such as these.

According to the invention, the appliance to be configured has at least one configuration means which can produce the actual configuration. For the purposes of the present invention, a distinction is drawn between configuration on the one hand and configuration information on the other hand. As defined above, the configuration is the totality of the states of the appliance which have an external effect. Configuration information, in contrast, is coded information, for example a text file, which, processed in a specific format, represents a configuration of the appliance. In the field of substation technology for power generation companies, configuration information such as this may, for example, be in the form of a substation configuration language (SCL) file. By setting up appropriate software and/or hardware components of the appliance to be configured on the basis of the configuration information, the configuration means produces the configuration which is then actually incorporated in the appliance. The hardware components are set up, for example, by configuration of logic links in an FPGA (Field Programmable Gate Array), a PLA (Programmable Logic Array) or a CPLD (Complex Programmable Logic Device).

The configuration server is located on the other side of the configuration system, and is connected via the network to the appliance to be configured. This configuration server may be a computer which is positioned as required and is thus also physically remote, etc., with whose aid the configuration of the appliance to be configured can be changed without any maintenance personnel having to travel to the appliance to be configured. This configuration server has two integrated means or “processors”, specifically firstly a means for determination of the present configuration, and secondly a composition means. The means for determination of the present configuration is a core item of the present invention, since the present configuration is the only basis which can be used to ensure that the reconfiguration of the appliance to be configured is carried out correctly, and that the appliance to be configured will still also operate after the reconfiguration. The composition means is used to create new configuration information which is compatible with the appliance to be configured and which can be sent to this appliance via the network. The present and new configuration information is received and sent via the standard components of the network.

The appliance to be configured preferably contains a means for provision of up-to-date configuration information.

There are various possible ways to implement this means for provision of up-to-date configuration information. In one simple case, the means has a memory in which the up-to-date configuration information is stored. This memory may, for example, also be used by the configuration means, in order to use the information contained in it for configuration of the appliance. The configuration information is thus provided simply by reading the memory, and can then be sent via the network to the configuration server.

Alternatively, the means for provision of the configuration information may also be a program object, which runs on a CPU, for determination of the configuration of the elements of the appliance to be configured, and may be used for creation of configuration information. In this embodiment, the means can determine the overall configuration of the appliance via suitable mechanisms that are implemented in the appliance and can then generate configuration information on an ad hoc basis, for example a correspondingly suitable SCL file. This variant does not require any additional memory, and ensures that the configuration set at any given time in the appliance is always sent as configuration information to the configuration server.

A means for determination of the present configuration is provided at the configuration server end. In one simple embodiment, this may be a memory in which the up-to-date configuration information at least about the appliance to be configured is stored, and which can provide this information. This storage process may be dependent on configuration information which has been created on the appliance to be configured or may exist independently of it. Provided that it is certain that the configuration information contained in the memory actually reflects the present configuration, there is no need to access the means for creation of up-to-date configuration information. Subject to the given preconditions, this can thus also be omitted.

It is important for the invention for the capability to be provided to notify the configuration server of the actual and present configuration of the appliance to be configured. This is the only way to ensure that the new configuration to be created is compatible with the previous configuration, and that the appliance to be configured still operates.

The composition means preferably has a program object, which runs on a CPU, for determination of the configuration of the appliance to be configured and for creation of new configuration information on the basis of the configuration information about the appliance to be configured.

The composition means is designed such that it uses the up-to-date configuration information as the basis for creation of the new configuration information. This makes it possible to ensure that the new configuration information is compatible with the appliance to be configured.

The appliance to be configured is preferably a substation appliance or a substation, for example a substation for power distribution technology.

The invention likewise relates to a method for reconfiguration of appliances in a network of appliances and configuration servers. All that has been stated with respect to the configuration server according to the invention applies equally to the method according to the invention, so that reference is made to the entire contents of what has been stated above. Equally, the statements in the following text relating to the method also apply to the configuration server. The method according to the invention comprises the following steps:

determination of the present configuration of the appliance to be reconfigured;

creation of new configuration information which is suitable for the appliance and satisfies changed requirements for the appliance, on the basis of the present configuration and the requirements;

transmission of the new configuration information to the appliance to be configured; and

reconfiguration of the appliance on the basis of the new configuration information.

In this method according to the invention, information, the configuration which is currently located in the appliance and requirements for a new configuration are linked to one another and are processed such that working new configuration information can be used for configuration of the appliance. A first important step in the method is the determination of the present configuration. In one simple exemplary embodiment of the invention, the determination of the up-to-date configuration information may be obtained simply by reading a memory, which contains the up-to-date configuration information on the configuration server. In this example of the method according to the invention, there is still no need for contact with the appliance to be configured, during this step. This variant of the method according to the invention can be used only when it is possible to ensure that the present configuration on the appliance to be configured is represented completely and correctly by the configuration information located on the configuration server. Thus, in situations such as this, the operators of the appliances and of the configuration system must ensure that

1. the identity of the appliance is defined, in order that no confusion can occur,

2. no on-site changes which have not been notified to the configuration server have been made to the configuration of the appliance, and

3. changes to the configuration which have been carried out by the configuration server have always led to corresponding changes to the configuration information in the memory of the configuration server.

In fact, in present-day substation control practice, this can frequently not be guaranteed. Generally, the manufacturer has no further control over appliances which have been sold to the operator. Should appliances such as these be subsequently reconfigured by the manufacturer, it is frequently impossible to obtain more than one address information item for the appliance, reflecting its IP address (or other network address). The person carrying out the configuration work, for example the manufacturer of the appliance or a maintenance company, can therefore not generally assume that it will be possible to find a specific appliance at a specific address in the network. It is therefore preferable for the determination of the present configuration to comprise the following steps according to the invention:

checking an identification designation for the appliance to be configured;

checking configuration change information for the appliance to be configured;

if the configuration change information indicates that the configuration of the appliance to be configured has not changed, and that the configuration information on the configuration server thus corresponds to the present configuration of the appliance to be configured: reading of the configuration information, which is stored on the configuration server, on the basis of the identification designation; or

if the configuration change information indicates that the configuration of the appliance to be configured has changed, and that the configuration information on the configuration server thus does not correspond to the present configuration of the appliance to be configured: reading up-to-date configuration information which is stored on the appliance to be configured.

The identification designation of the appliance to be configured is used to identify the appliance uniquely among all the existing appliances. This makes it possible to prevent confusion between appliances which appear to be similar. In this embodiment of the present invention, a check is first of all carried out to determine whether the configuration of the appliance may possibly have changed. This should be understood as meaning that a change has been made to the configuration of the appliance since the configuration information that was up to date at that time has been fed into the memory of the configuration server. In practice, this may be achieved, for example, by setting the configuration change information to a specific value after reading the up-to-date configuration information and storing it in the configuration server. This then corresponds to the information that the configuration has not been changed, and that the configuration information on the configuration server is thus up to date. If any changes have been made to the appliance and to its configuration, the software of the appliance automatically sets the configuration change information to a second value, which then indicates to the configuration server that a change has been carried out, and that the configuration information in the memory of the configuration server no longer reflects the present configuration of the appliance to be configured. This is the only situation in which the appliance to be configured requests up-to-date configuration information. This variant of the method according to the invention reduces the amount of data to be transmitted particularly in heavily loaded networks or in networks with only a narrow bandwidth, and can thus contribute to reducing the load on the network.

A further possible way to carry out this method step is simply for the appliance to be configured to always check the up-to-date configuration information, in which case this configuration information may also, but need not necessarily, include an identification designation.

This variant can be implemented particularly easily and, with the present-day transmission performance of conventional networks, represents probably the best variant, and is thus particularly preferred.

The creation of new configuration information may comprise the following steps:

determination of the desired new configuration of the appliance to be configured;

comparison of the requirements needed by the desired new configuration for the appliance to be configured with the actually available configuration capabilities of the appliance on the basis of the up-to-date configuration information; and

generation of new configuration information, which makes the desired new configuration match as well as possible the configuration capabilities of the appliance; or

determination of any compatibility between the desired new configuration and the configuration capabilities of the appliance, and generation of new configuration information on the basis of the desired configuration; or

determination of any incompatibility between the desired new configuration and the configuration capabilities of the appliance; and emission of a warning.

The desired new configuration is in this case meta information which, for example, has been obtained using a planning tool that operates on an abstract basis, and indicates the configuration that the appliance should have in order to make it possible to satisfy the desired new functionality.

For the purposes of the present invention, the expression configuration capabilities of an appliance means the totality of all the possible configurations of the entire appliance and/or of its individual elements. Modern intelligent electronic appliances which are used as control appliances for power supply technology are largely freely programmable. However, the configuration capability is restricted on the basis of physical and software limits of the control appliances and of the primary appliances which are controlled by them, so that not all configurations are worthwhile. For example, an appliance which has a specific number of outputs for the switching of lines is not able to switch more than precisely this number of lines. Furthermore, it is impossible to connect more sensors of the appliance to lines than there are sensors in the appliance. The switching rate and the type of information evaluated by an appliance may also be limiting factors of the overall capability of an appliance. Furthermore, in the context of a configuration to be changed, the configuration capabilities may also be determined by necessities which have to be considered in that context. For example, it is possible for certain configuration capabilities not to be feasible in the given environment of the appliance, although in principle they are available, since functions of the appliance configured at that time would then fail in a manner which could possibly present a safety hazard. Thus, for example, the appliance can implement a protective function which is intended to be reprogrammed to respond to a changed characteristic variable. In this case, it is necessary to ensure that the newly programmed protective function does not exceed the capabilities of the appliance. A further example may be the change in the current level which can flow through a specific line. In this case, it is necessary during the reconfiguration process to ensure that the intended current level does not exceed the load limit of the switch that switches that line.

The stated restrictions to the configuration capability are explicitly included in the up-to-date configuration information, or can be determined from this configuration information. By way of example, a number of input/output interfaces or parameters of protective and control functions are explicitly available. Conditions for a locking procedure which can be determined on the basis of a topology of busbars and switches, for example, are implicitly available.

The configuration capabilities of the appliance to be configured are determined on the basis of the up-to-date configuration information which has been determined as described above. These capabilities form the basis for the examination of the further reconfiguration capability of the appliance.

There are various options for the actual generation of the new configuration information. The most promising approach is to generate configuration information which takes account not only of the requirements of the desired new configuration but also of the resultant necessities on the basis of the present configuration. In this variant, by way of example, an expert system is used for configuration, which assumes the restrictions to the configuration capability that have been mentioned to be fixed boundary conditions and changes only the configuration of those elements which can be configured by remote control. In a simpler variant, the compatibility between the desired new configuration and the configuration produced independently by the system can be checked and, if the result is positive, the configuration information can be generated or, if it is found that there is an incompatibility, the generation process can be terminated or not even started at all and, if appropriate, a warning can be emitted. A maintenance technician or the like can then use this information to adapt the desired configuration and once again to carry out the method according to the invention.

In addition to the warning, it is also possible at the same time to output further information about the specific causes of the incompatibility, in order to provide the maintenance technician with a justification for changes.

### BRIEF DESCRIPTION OF THE DRAWINGS

The subject matter of the invention will be explained in more detail in the following text with reference to a preferred exemplary embodiment, which is illustrated in the attached drawing, in which:

FIG. 1 shows a schematic illustration of a switchgear assembly and of an associated control system.

The reference symbols used in the drawing, and their meanings, are listed in summary form in the list of reference symbols.

Approaches to Implementation of the Invention

FIG. 1 shows a schematic illustration of a switchgear assembly or substation for an electrical power distribution network, and an associated control system. The illustration shows three fields E1Q1, E1Q2 and E1Q3 of a switchgear assembly, and a control station AA1, with a data processing appliance KA0 with the conventional input and output means for control by a user. The control station AA1 is arranged in the substation itself, or is arranged remotely in a control center of a network operator, and is connected via a communication network NW to a higher-level bus YW1 of the substation. A remote configuration server is likewise connected for communication purposes via the communication network NW and via the higher-level bus YW1 to control appliances for the system. The individual fields E1Q1, E1Q2 and E1Q3 each have control appliances, namely controllers KA1, protective devices FA1 or input/output appliances KB1. The control appliances control, regulate, monitor and protect associated primary appliances in the system, which carry out the actual system purpose. Primary appliances are, for example, circuit breakers, isolators, overhead lines, transformers, generators or motors.

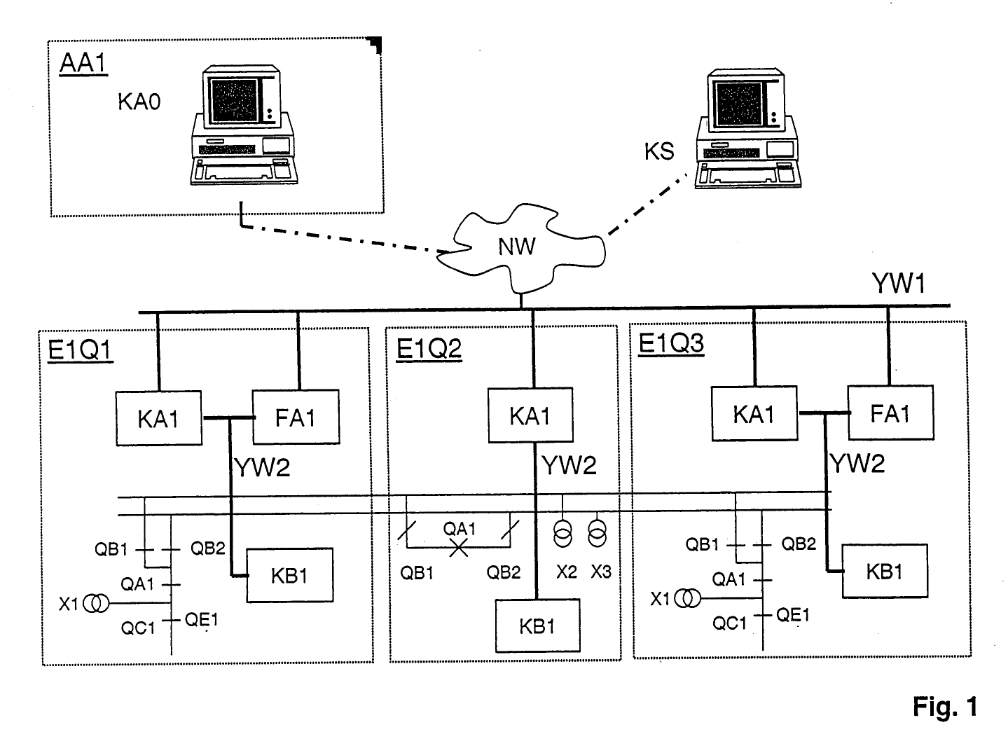

Control system functions for controlling and monitoring the primary appliances are installed on the control appliances. The control appliances are connected to one another by communication means, in the example by means of the higher-level bus YW1 and by process buses YW2. The control system functions are associated with primary appliances such as switches QA1, isolators QB1, QB2 and voltage sensors or voltage measurement appliances X1, X2, X3. The primary appliances are connected to one another by means of electrical connections which carry power, that is to say for example via busbars, field nodes and outgoers. These connections can be described as the topology of the primary appliances.

The designations KA1, FA1, KB1, YW1, etc. denote actual appliances and control system functions of a system. In order to identify a specific appliance uniquely, it is preceded by the designation of the field. For example, E1Q1A1 thus denotes a switch QA1 in the field E1Q1.

Let us now assume, as an example, that the controller KA1 in the field E1Q1 is intended to be equipped with new or updated control software. This software is configured by the manufacturer of the controller, that is to say suitable software modules are configured and are combined with one another. This configuration has to match the actual design of the substation and, in particular, of the field E1Q1. This match has to exist in various areas:

addresses of appliances on the various communication buses YW1, YW2,

addresses of input/output interfaces,

memory and computation capacity of the field device,

nature of the control function, requirements for the control function,

nature and parameters for the controlled primary appliance or appliances, and

topology of the primary appliances.

It is possible for a system operator to make changes to the system in the areas mentioned above and to reconfigure the control appliances accordingly, without the manufacturer of the control appliances being aware of this.

For example, the power capacity of an outgoer may be changed, or the system topology may be changed by the installation of new elements such as switches, isolators or outgoers. Control and protective functions in the control appliances are adapted in a corresponding manner. If the manufacturer creates the software in accordance with the obsolete configuration information and there is therefore a mismatch, the controller will either not operate at all once the new software has been loaded, or else it will operate incorrectly or will not guarantee the required safety.

According to the invention, up-to-date configuration information is therefore determined and is transmitted to the configuration server KS. In one preferred variant of the invention, the up-to-date configuration information includes a description of the primary appliances, which is important for the control appliance to be configured, and of their topology. This description relates, for example, to primary appliances in a switch field with which the control appliance is associated, or to primary appliances on a specific busbar, or to primary appliances throughout the entire substation. Depending on the nature of the primary appliance, the description includes, for example, maximum permissible values for the voltage, current and power, switching times, information relating to measurement circuits, that is to say the nature and parameters of the instrument transformers and sensors, the type of circuit breaker or isolator, the configuration of the grounding system, the circuit diagram, characteristics of gas leakage sensors, proximity switches, etc.

New configuration information is determined in the configuration server KS using a composition means. The new configuration information corresponds to the new program units for operation of the controller. These program units are consistent with the up-to-date configuration information, that is to say these program units can be loaded into the controller and can be run correctly. The program units are programs for microprocessors and/or programs for programmable logic modules such as FPGAs (Field Programmable Gate Arrays). The program units are transmitted via the communication network NW and via the higher-level bus YW1 to the controller, and are loaded into a program memory or FPGA in this controller.

In one preferred variant of the invention, an updated description of appliance functions and appliance interfaces is additionally or alternatively transmitted to the controller using SCL, and is used for configuration of the controller.

List of Reference Symbols

| | |
|---|---|
| QA1 | Switch |
| QB1 | Isolator |
| X1, X2, X3 | Voltage sensor |
| YW1 | Higher-level bus |
| YW2 | Process bus |
| KA1 | Controller |
| FA1 | Protective device |
| KB1 | Input/output appliance |
| KS | Configuration server |
| NW | Communication network |

1. A configuration system for configuration of appliances in voltage networks having
at least one appliance to be configured and having elements which are configured in a specific manner, and
configuration means for reconfiguration of the appliance on the basis of received new configuration information; and
a configuration server, which is connected via a communication network to the at least one appliance to be configured and which has composition means for creation of new configuration information for the appliance to be configured and means for determination of the present configuration of the at least one appliance to be configured.

2. The configuration system as claimed in claim 1, characterized in that the present configuration has a description of primary appliances which are associated with the appliance to be configured.

3. The configuration system as claimed in claim 1 or 2, characterized in that the appliance to be configured also has a means for provision of up-to-date configuration information.

4. The configuration system as claimed in claim 3, characterized in that the means for provision of the configuration information has a memory for storage of the configuration information.

5. The configuration system as claimed in one of claims 3 or 4, characterized in that the means for provision of the configuration information is a program object, which runs on a CPU, for determination of the configuration of the elements of the appliance to be configured, and for creation of configuration information.

6. The configuration system as claimed in one of claims 1 to 5, characterized in that the means for determination of the present configuration has a memory for storage of configuration information at least about the appliance to be configured.

7. The configuration system as claimed in one of claims 1 to 6, characterized in that the composition means have a program object, which runs on a CPU, for determination of the configuration of the appliance to be configured and for creation of new configuration information on the basis of the configuration information about the appliance to be configured.

8. The configuration system as claimed in one of claims 1 to 7, characterized in that the appliance to be configured is a substation appliance or a substation.

9. A method for reconfiguration of appliances in a network of appliances and configuration servers comprising the following steps:
determination of the present configuration of the appliance to be reconfigured;
creation of new configuration information which is suitable for the appliance and satisfies changed requirements for the appliance, on the basis of the present configuration and the requirements;
transmission of the new configuration information to the appliance to be configured; and
reconfiguration of the appliance on the basis of the new configuration information.

10. The method as claimed in claim 9, characterized in that the present configuration has a description of primary appliances which are associated with the appliance to be configured.

11. The method as claimed in claim 9 or 10, characterized in that the present configuration is determined by reading up-to-date configuration information which is stored on the configuration server.

12. The method as claimed in claims 9 to 11, characterized in that the determination of the present configuration comprises the following steps:
checking an identification designation for the appliance to be configured;
checking configuration change information for the appliance to be configured;
if the configuration change information indicates that the configuration of the appliance to be configured has not changed, and that the configuration information on the configuration server thus corresponds to the present configuration of the appliance to be configured:
reading of the up-to-date configuration information, which is stored on the configuration server, on the basis of the identification designation;
or, if the configuration change information indicates that the configuration of the appliance to be configured has changed, and thus that the configuration information on the configuration server does not correspond to the present configuration of the appliance to be configured:
reading up-to-date configuration information which is stored on the appliance to be configured.

13. The method as claimed in claims 9 to 11, characterized in that the determination of the present configuration comprises the following steps:
reading of configuration information, which is stored on the appliance to be configured, about the present configuration.

14. The method as claimed in one of claims 9 to 13, characterized in that the creation of new configuration information comprises the following steps:
determination of the desired new configuration of the appliance to be configured;
comparison of the requirements needed by the desired new configuration for the appliance to be configured with the actually available configuration capabilities of the appliance on the basis of the up-to-date configuration information; and
generation of new configuration information, which makes the desired new configuration match as well as possible the configuration capabilities of the appliance; or
determination of any compatibility between the desired new configuration and the configuration capabilities of the appliance, and generation of new configuration information on the basis of the desired configuration; or
determination of any incompatibility between the desired new configuration and the configuration capabilities of the appliance and emission of a warning.
